(19) United States
(12) Patent Application Publication
(10) Pub. No.: US 2017/0099348 A1
(43) Pub. Date: Apr. 6, 2017

(54) FEDERATED VIEW OF MULTIPLE STORAGE SYSTEMS

(71) Applicant: INTERNATIONAL BUSINESS MACHINES CORPORATION, Armonk, NY (US)

(72) Inventors: Amihay BIRENBOIM, Tel Aviv (IL); Brian M. BURNETTE, Durham, NC (US); Elizabeth MITCHELL, Cary, NC (US); Jason L. PEIPELMAN, Austin, TX (US)

(73) Assignee: INTERNATIONAL BUSINESS MACHINES CORPORATION, Armonk, NY (US)

(21) Appl. No.: 14/875,856

(22) Filed: Oct. 6, 2015

(51) Int. Cl. H04L 29/08

(52) U.S. Cl. CPC H04L 67/1061; H04L 67/1097

(57) ABSTRACT

Various embodiments for managing a plurality of storage systems in a computer storage environment, by a processor device, are provided. In one embodiment, a method comprises using a single interface that performs peer-to-peer discovery to create and display a federated view of managed storage systems within the plurality of storage systems in a storage network.

### BACKGROUND OF THE INVENTION

Field of the Invention

The present invention relates in general to computing systems, and more particularly, to various embodiments for managing storage systems in computer storage networks.

Description of the Related Art

Today with modern technology, large volumes of data are storable on disk drives; these drives can exist as a solo entity, or as part of a broader make up within a larger storage environment, for example, as part of a Storage Area Network (SAN), or Software Defined Storage (SDS) systems, such as a Virtual Storage Area Network (VSAN). As the sheer volume of data in today's information-based society continues to increase, so too does the demands placed on communications and data processing infrastructures that serve to manipulate, transfer, and otherwise handle this data.

### SUMMARY OF THE INVENTION

Various embodiments for managing a plurality of storage systems in a computer storage environment, by a processor device, are provided. In one embodiment, a method comprises using a single interface that performs peer-to-peer discovery to create and display a federated view of managed storage systems within the plurality of storage systems in a storage network.

In addition to the foregoing exemplary embodiment, various other system and computer program product embodiments are provided and supply related advantages. The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a block diagram showing an exemplary hardware structure for effecting data routing management, in which aspects of the present invention may be realized;

FIG. 2 illustrates an additional block diagram of an exemplary hardware structure, specifically portions of a complex SAN, again, in which aspects of the present invention may be realized;

FIG. 3 illustrates a flow chart of a method for managing a plurality of storage systems, in accordance with embodiments of the present invention;

FIG. 4 illustrates a diagram of an interface for managing a plurality of storage systems, in accordance with embodiments of the present invention; and

FIG. 5 illustrates an additional flow chart of a method for managing a plurality of storage systems, in accordance with embodiments of the present invention.

### DETAILED DESCRIPTION OF THE DRAWINGS

Described embodiments, and illustrative Figures of embodiments for managing a plurality of storage systems in a computer storage environment are to follow. In the interest of clarity, not all features of an actual implementation are described in this Specification. It will of course be appreciated by the skilled artisan, that in the development of any such actual embodiment, numerous implementation-specific decisions must be made to achieve the developers specific goals, such as compliance with system-related and business-related constraints, which will vary from one implementation to another. Furthermore, it will be appreciated that such a development effort may be complex and labor-intensive, but would nevertheless be a routine undertaking for those of ordinary skill in the art having the benefit of this Disclosure.

Complex Storage Area Network (SAN) or Virtual Storage Area Network (VSAN) configurations enable large numbers of computing components such as servers to access common storage via interconnection switches and cabling. The availability, integrity and recovery of these interconnections is critical to the reliable operations of the systems. Networks are often implemented with redundant routes, in conjunction with server multipath drivers allowing for failing commands to be recovered down alternate paths and avoiding outages and individual path failures.

Because such networks may comprise a growing number of computing components, such as storage systems, gaining quick access to view multiple connected storage systems and top level information thereof has become a challenging necessity. Traditional native storage system interfaces do not allow federated management of multiple connected storage systems in a single interface context. While some existing interfaces allow for rudimentary navigation between connected storage systems, they do not provide management for multiple connected systems in a single interface, nor do they provide top level information, such as characteristic and troubleshooting information regarding the connected systems.

In view of the foregoing, the mechanisms of the illustrated embodiments provide various solutions to the previous challenges for managing multiple storage systems in a computer storage environment. These mechanisms include such functionality as using a single interface that performs peer-to-peer discovery to create and display a federated view of managed storage systems, as will be further described.

The mechanisms may be applicable to a variety of network topologies and network components as will be further described. Notwithstanding the illustration of some of the functionality attendant to the various embodiments, one of ordinary skill will appreciate that the methodologies herein may be adapted to a wide variety of implementations and scenarios as noted above.

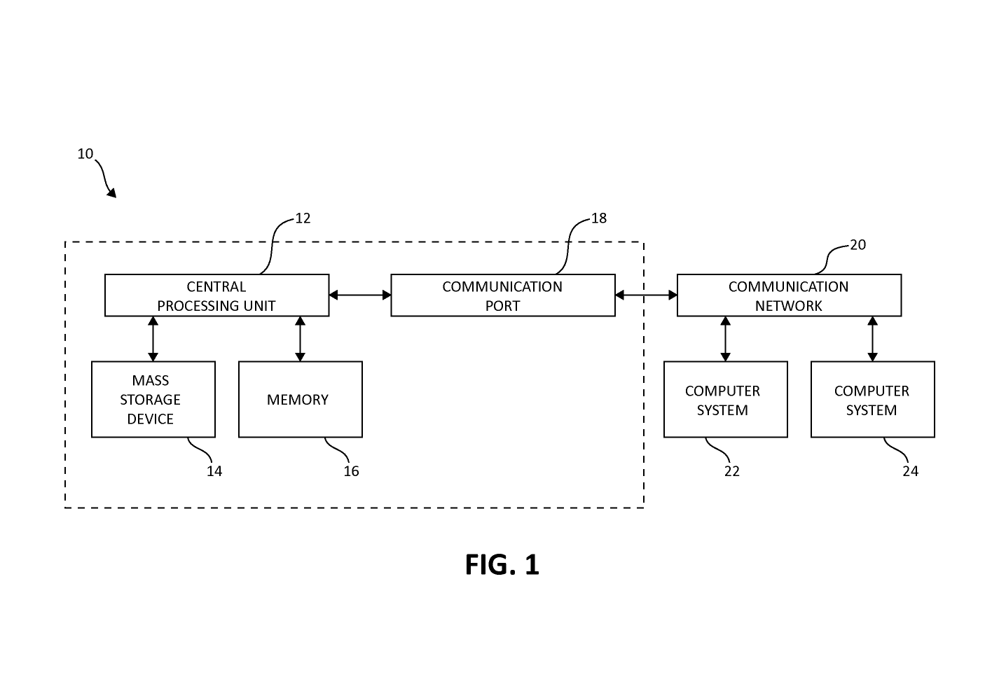

Turning now to FIG. 1, exemplary architecture 10 of a computing system environment is depicted. Architecture 10 may, in one embodiment, be implemented at least as part of a system for effecting mechanisms of the present invention. The computer system 10 includes central processing unit (CPU) 12, which is connected to communication port 18 and memory device 16. The communication port 18 is in communication with a communication network 20. The communication network 20 and storage network may be configured to be in communication with server (hosts) 22, 24 and storage systems, which may include storage devices 14. The storage systems may include hard disk drive (HDD) devices, solid-state devices (SSD) etc., which may be configured in a redundant array of independent disks (RAID). The communication port 18, communication network 20, and other components not pictured for the sake of brevity but known to the skilled artisan may include such hardware components as fibre channel cabling, fibre channel ports, Host-Bus Adapters (HBAs), Converged Network Adapters (CNAs), network switches and switching components, and similar communications mechanisms known to one of ordinary skill in the art. Various aspects of the illustrated embodiments may be realized using one or more of these components as will be further described.

The operations as described below may be executed on storage device(s) 14, located in system 10 or elsewhere and may have multiple memory devices 16 working independently and/or in conjunction with other CPU devices 12. Memory device 16 may include such memory as electrically erasable programmable read only memory (EEPROM) or a host of related devices. Memory device 16 and storage devices 14 are connected to CPU 12 via a signal-bearing medium. In addition, CPU 12 is connected through communication port 18 to a communication network 20, having an attached plurality of additional computer host systems 22, 24. In addition, memory device 16 and the CPU 12 may be embedded and included in each component of the computing system 10. Each storage system may also include separate and/or distinct memory devices 16 and CPU 12 that work in conjunction or as a separate memory device 16 and/or CPU 12.

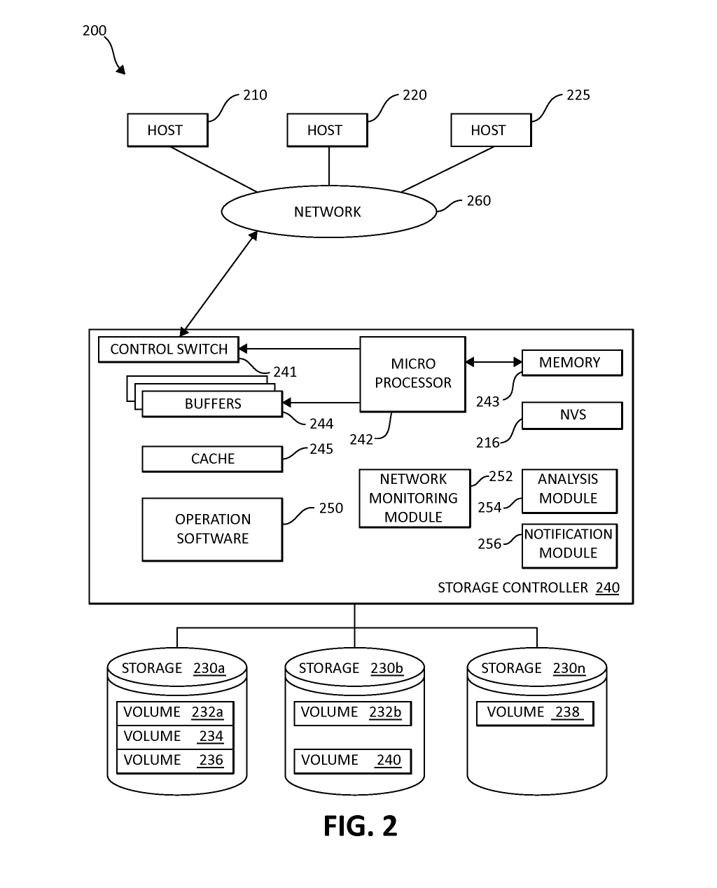

FIG. 2 is an exemplary block diagram 200 showing a hardware structure of a data storage and management system (specifically, portions of a SAN 200) that may be used in accordance with embodiments of the present invention. Host computers 210, 220, 225, are shown, each acting as a central processing unit for performing data processing as part of a data storage system 200. The cluster hosts/nodes (physical or virtual devices), 210, 220, and 225 may be one or more new physical devices or logical devices to accomplish the purposes of the present invention in the data storage system 200.

A Network connection 260 may be a fibre channel fabric, a fibre channel point to point link, a fibre channel over ethernet fabric or point to point link, a FICON or ESCON I/O interface, any other I/O interface type, a wireless network, a wired network, a LAN, a WAN, heterogeneous, homogeneous, public (i.e. the Internet), private, or any combination thereof. The hosts, 210, 220, and 225 may be local or distributed among one or more locations and may be equipped with any type of fabric (or fabric channel) (not shown in FIG. 2) or network adapter 260 to the storage controller 240, such as Fibre channel, FICON, ESCON, Ethernet, fiber optic, wireless, or coaxial adapters. Data storage system 200 is accordingly equipped with a suitable fabric (not shown in FIG. 2) or network adaptor 260 to communicate. Data storage system 200 is depicted in FIG. 2 comprising storage controllers 240 and cluster hosts 210, 220, and 225. The cluster hosts 210, 220, and 225 may include cluster nodes and other network components known to one of ordinary skill in the art.

To facilitate a clearer understanding of the methods described herein, storage controller 240 is shown in FIG. 2 as a single processing unit, including a microprocessor 242, system memory 243 and nonvolatile storage (“NVS”) 216. It is noted that in some embodiments, storage controller 240 is comprised of multiple processing units, each with their own processor complex and system memory, and interconnected by a dedicated network within data storage system 200. Storage 230 (labeled as 230a, 230b, and 230n herein) may be comprised of one or more storage devices, such as storage arrays, which are connected to storage controller 240 (by a storage network) with one or more cluster hosts 210, 220, and 225 connected to each storage controller 240 through network 260. While one data connection between components (such as between storage 230 and storage controller 240, and network connection 260 and cluster hosts 210, 220, and 225) is shown for purposes of brevity, one of ordinary skill in the art will appreciate that a number of network connections, or “paths” may be found in a particular system or scenario in which data is transferred. These paths form the multipath architecture of storage networks in which the mechanisms of the present invention are concerned, among other aspects. In addition, alternate network paths appreciated by one of ordinary skill in the art may be found.

Storage controller 240 manages storage 230 and facilitates the processing of write and read requests intended for storage 230. The system memory 243 of storage controller 240 stores program instructions and data, which the processor 242 may access for executing functions and method steps of the present invention for executing and managing storage 230 as described herein. In one embodiment, system memory 243 includes, is in association with, or is in communication with the operation software 250 for performing methods and operations described herein. As shown in FIG. 2, system memory 243 may also include or be in communication with a cache 245 for storage 230, also referred to herein as a “cache memory”, for buffering “write data” and “read data”, which respectively refer to write/read requests and their associated data. In one embodiment, cache 245 is allocated in a device external to system memory 243, yet remains accessible by microprocessor 242 and may serve to provide additional security against data loss, in addition to carrying out the operations as described in herein.

In some embodiments, cache 245 is implemented with a volatile memory and non-volatile memory and coupled to microprocessor 242 via a local bus (not shown in FIG. 2) for enhanced performance of data storage system 200. The NVS 216 included in data storage controller is accessible by microprocessor 242 and serves to provide additional support for operations and execution of the present invention as described in other figures. The NVS 216, may also referred to as a “persistent” cache, or “cache memory” and is implemented with nonvolatile memory that may or may not utilize external power to retain data stored therein. The NVS may be stored in and with the cache 245 for any purposes suited to accomplish the objectives of the present invention. In some embodiments, a backup power source (not shown in FIG. 2), such as a battery, supplies NVS 216 with sufficient power to retain the data stored therein in case of power loss to data storage system 200. In certain embodiments, the capacity of NVS 216 is less than or equal to the total capacity of cache 245.

Storage 230 may be physically comprised of one or more storage devices, such as a hard disk, magnetic tape, solid-state flash memory, or other non-volatile memory or any combination thereof. Additionally, Storage 230 may be physically comprised of one or more storage devices such as storage arrays. A storage array is a logical grouping of individual storage devices, such as a hard disk. In certain embodiments, storage 230 is comprised of a JBOD (Just a Bunch of Disks) array or a RAID (Redundant Array of Independent Disks) array. A collection of physical storage arrays may be further combined to form a rank, which dissociates the physical storage from the logical configuration. The storage space in a rank may be allocated into logical volumes, which define the storage location specified in a write/read request.

In one embodiment, by way of example only, the storage system as shown in FIG. 2 may include a logical volume, or simply “volume,” may have different kinds of allocations. Storage 230a, 230b and 230n are shown as ranks in data storage system 200, and are referred to herein as rank 230a, 230b and 230n. Ranks may be local to data storage system 200, or may be located at a physically remote location. In other words, a local storage controller may connect with a remote storage controller and manage storage at the remote location. Rank 230a is shown configured with two entire volumes, 234 and 236, as well as one partial volume 232a. Rank 230b is shown with another partial volume 232b. Thus volume 232 is allocated across ranks 230a and 230b. Rank 230n is shown as being fully allocated to volume 238—that is, rank 230n refers to the entire physical storage for volume 238. From the above examples, it will be appreciated that a rank may be configured to include one or more partial and/or entire volumes. Volumes and ranks may further be divided into so-called “tracks,” which represent a fixed block of storage. A track is therefore associated with a given volume and may be given a given rank.

The storage controller 240 may include operation software 250, a network monitoring module 242, an analysis module 254, and a notification module 256. The operation software 250, network monitoring module 242, analysis module 254, and notification module 256 may work in conjunction with each and every component of the storage controller 240, the hosts 210, 220, 225, and storage devices 230. The operation software 250, network monitoring module 242, analysis module 254, and notification module 256 may be structurally one complete module or may be associated and/or included with other individual modules. The operation software 250, network monitoring module 242, analysis module 254, and notification module 256 may also be located in the cache 245 or other components of portion 200.

The operation software 250, network monitoring module 242, analysis module 254, and notification module 256 may individually and/or collectively perform various aspects of the present invention as will be further described. For example, the operation software 250 may contain executable code for performing network test and evaluation functionality. The network monitoring module 252 may implement one or more monitoring processes. The network monitoring module 252 may monitor individual SAN components and/or data transmission between SAN components. For example, network monitoring module 252 may monitor data exchanges across particular data communication paths. The analysis module 254 may be used to configure certain techniques for multipath management in routing certain predefined input/output (I/O) traffic across the SAN as will be further described. Finally, the notification module 256 may send notification messages to other components in the portion 200 or elsewhere about various network status or multipath management actions taken.

The storage controller 240 includes a control switch 241 for controlling the fiber channel protocol to the host computers 210, 220, 225, a microprocessor 242 for controlling all the storage controller 240, a nonvolatile control memory 243 for storing a microprogram (operation software) 250 for controlling the operation of storage controller 240, data for control, cache 245 for temporarily storing (buffering) data, and buffers 244 for assisting the cache 245 to read and write data, a control switch 241 for controlling a protocol to control data transfer to or from the storage devices 230, and other components in the storage controller 240. Multiple buffers 244 may be implemented with the present invention to assist with the operations as described herein. In one embodiment, the cluster hosts/nodes, 210, 220, 225 and the storage controller 240 are connected through a network adaptor (this could be a fibre channel) 260 as an interface i.e., via at least one switch called “fabric.”

In view of the exemplary hardware structures depicted in FIGS. 1 and 2 previously, the mechanisms of the present invention may, as one of ordinary skill in the art will appreciate, be implemented and/or utilized in a wide variety of physical locations including, but not limited to Host-Bus Adapters (HBAs), Converged Network Adapters (CNAs), switch ports, storage ports, and the like.

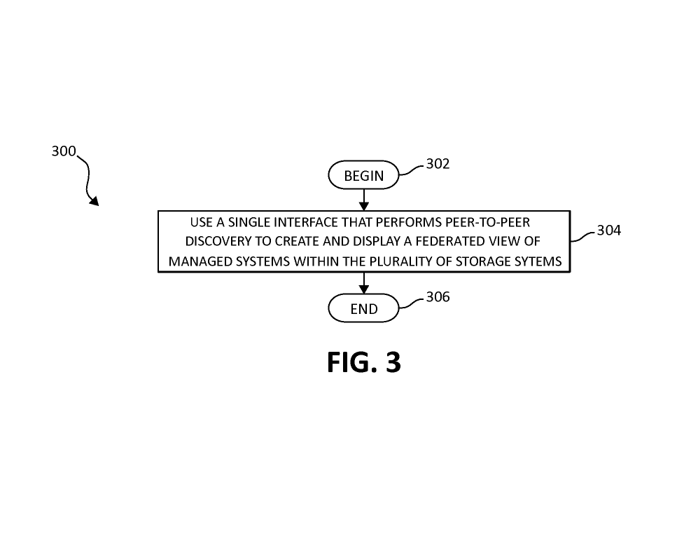

Continuing to FIG. 3, a method 300 for managing a plurality of storage systems in a computer storage environment is provided. Beginning at step 302, a single interface that performs peer-to-peer discovery to create and display a federated view of managed storage systems within the plurality of storage systems in a storage network is employed (step 304). The interface may be provided as a user interface, such as a Graphical User Interface (GUI) or Command-Line Interface (CLI), which displays the plurality of managed storage systems and top level characteristic and troubleshooting information of such. The mechanisms of the illustrated embodiments may be particularly well suited to flash storage environments, however, one skilled in the art would widely recognize the embodiments described herein may be suited to a wide variety of storage system environments. The method ends (step 306).

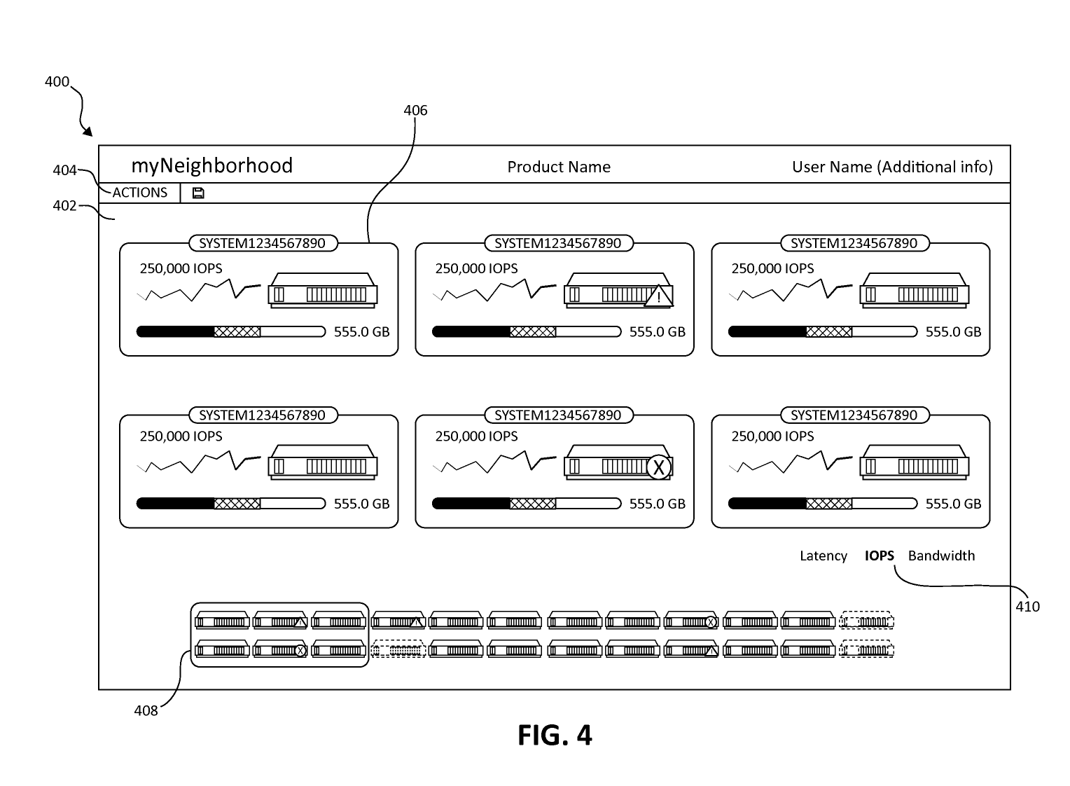

FIG. 4 illustrates an interface 400 for managing a plurality of storage systems in a computer storage environment. Note that interface 400 is provided as an example only and that in an actual implementation of the present invention, each illustrative feature hereinafter described may be provided in a view accustomed to the needs of the implementer. One of ordinary skill in the art would recognize that the elements of interface 400 may be displayed in a variety of configurations while staying within the spirit and scope of the present invention.

Interface 400 illustrates a main body 402 which may display one or more managed storage systems 406, and one or more discovered storage systems 408. Interface 400 may include an action menu 404 for creating a personalized neighborhood of discovered storage systems 408 and managed storage systems 406, navigating commands, or otherwise related input commands. Interface 400 may also have a characteristic menu 410 for switching view of top level characteristic or troubleshooting information displayed in, and regarding the managed storage systems 406 (e.g. Input/Output Rate Per Second (IOPS), Bandwidth, and/or Latency information, or other metrics).

The display of discovered storage systems 408 may include peer-to-peer discovered storage systems of which a user is currently authenticated on as well as unauthenticated storage systems or storage systems which may not be attainable (e.g. wireframe systems). The authenticated of the discovered storage systems 408 may be fully colored or bolded, while unauthenticated or otherwise unreachable systems may be displayed in grayscale or outline dotted. Each of the discovered storage systems 408 may display information alerts pertaining to the individual storage system. Discovered storage systems 408 may be displayed such as storage system names, avatars, or any other acceptable method known in the art.

In one embodiment, managed storage systems 406 may be visible in the main body 402 as one or more storage systems selected or highlighted by the user from the display of discovered storage systems 408. Managed storage systems 406 may be presented as separate entities (e.g. boxes) containing related information pertaining to the individual storage system, such as the storage system name, top level storage system characteristic and troubleshooting information, storage system capacity, etc.

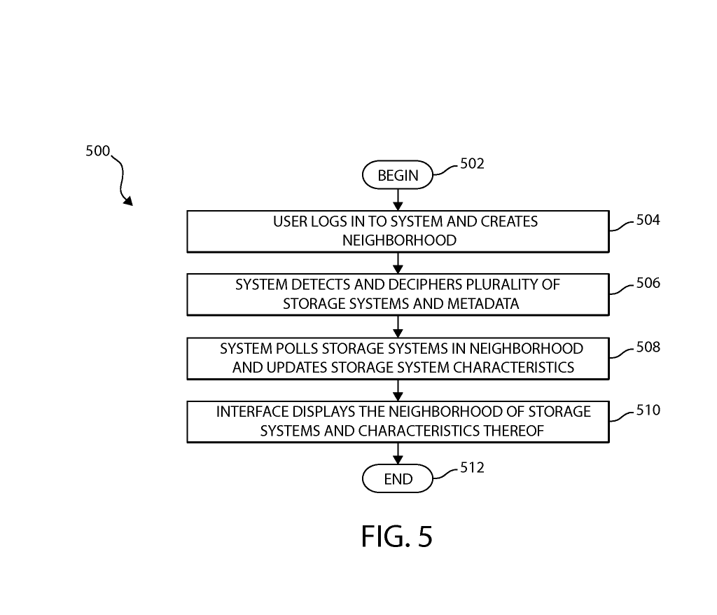

FIG. 5 illustrates a method 500 for managing a plurality of storage systems in a computer storage environment. Beginning at step 502, a user logs into a system native to the storage system currently being accessed, and creates a neighborhood (step 504). When accessing the system, it is assumed the login credentials are equivalent to all discovered storage systems 408. The user may be authenticated to the system using any known secure method known in the art (e.g. Lightweight Directory Access Protocol (LDAP)). After creating a personalized neighborhood of connected storage systems individual to the user, the system detects and deciphers discovered storage systems 408 and the metadata thereof (step 506). If a metadata mismatch is detected between discovered storage systems 408 (the authentication credentials are not the same), the user may log into the disabled storage system using its unique credentials while remaining in the neighborhood view, and staying within the context of the single interface. The discovered storage system 408 with the metadata mismatch, which would have been previously disabled by grayscale or dotted line, then becomes fully accessible to the user.

Continuing in method 500, the system then polls the known storage systems to retrieve and display the top level characteristic and troubleshooting information of each storage system, which may include such information as status, health, and performance of each storage system (step 508). The top level characteristic and troubleshooting information is then provided and displayed to the user within interface 400 (step 510). The method ends (step 512).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing a plurality of storage systems in a computer storage environment, by a processor device, comprising:
using a single interface that performs peer-to-peer discovery to create and display a federated view of managed storage systems within the plurality of storage systems in a storage network.

2. The method of claim 1, further including creating a networked neighborhood within the interface, the networked neighborhood displaying discovered storage systems within the plurality of storage systems in the storage network.

3. The method of claim 2, further including displaying, within the networked neighborhood, authenticated and non-authenticated discovered storage systems within the plurality of storage systems in the storage network.

4. The method of claim 3, wherein the managed storage systems are authenticated storage systems developed from the discovered storage systems within the plurality of storage systems in the storage network.

5. The method of claim 1, further including displaying, by the interface, top level characteristic and troubleshooting information of each of the plurality of storage systems in the storage network.

6. The method of claim 5, further including polling each of the plurality of storage systems in the storage network to retrieve and display the top level characteristic and troubleshooting information.

7. The method of claim 1, wherein the interface is native to the plurality of storage systems, and the interface comprises one of a Graphical User Interface (GUI) or a Command-Line Interface (CLI).

8. A system managing a plurality of storage systems in a computer storage environment, comprising:
a plurality of storage systems, and
at least one processor device, operable within the computer storage environment, wherein the at least one processor device:
uses a single interface that performs peer-to-peer discovery to create and display a federated view managed storage systems within the plurality of storage systems in a storage network.

9. The system of claim 8, wherein the at least one processor device creates a networked neighborhood within the interface, the networked neighborhood displaying discovered storage systems within the plurality of storage systems in the storage network.

10. The system of claim 9, wherein the at least one processor device displays, within the networked neighborhood, authenticated and non-authenticated discovered storage systems within the plurality of storage systems in the storage network.

11. The system of claim 10, wherein the managed storage systems are authenticated storage systems developed from the discovered storage systems within the plurality of storage systems in the storage network.

12. The system of claim 8, wherein the at least one processor device displays, by the interface, top level characteristic and troubleshooting information of each of the plurality of storage systems in the storage network.

13. The system of claim 12, wherein the at least one processor device polls each of the plurality of storage systems in the storage network to retrieve and display the top level characteristic and troubleshooting information.

14. The system of claim 8, wherein the interface is native to the plurality of storage systems, and the interface comprises one of a Graphical User Interface (GUI) or a Command-Line Interface (CLI).

15. A computer program product for managing a plurality of storage systems in a computer storage environment by at least one processor device operable within computer storage environment, the computer program product embodied on a non-transitory computer-readable storage medium having computer-readable program code portions stored therein, the computer-readable program code portions comprising:
a first executable portion that uses a single interface that performs peer-to-peer discovery to create and display a federated view of managed storage systems within the plurality of storage systems in a storage network.

16. The computer program product of claim 15, further including a second executable portion that creates a networked neighborhood within the interface, the networked neighborhood displaying discovered storage systems within the plurality of storage systems in the storage network.

17. The computer program product of claim 16, further including a third executable portion that displays, within the networked neighborhood, authenticated and non-authenticated discovered storage systems within the plurality of storage systems in the storage network.

18. The computer program product of claim 17, wherein the managed storage systems are authenticated storage systems developed from the discovered storage systems within the plurality of storage systems in the storage network.

19. The computer program product of claim 15, further including a second executable portion that displays, by the interface, top level characteristic and troubleshooting information of each of the plurality of storage systems in the storage network.

20. The computer program product of claim 19, further including a third executable portion that polls each of the plurality of storage systems in the storage network to retrieve and display the top level characteristic and troubleshooting information.

21. The computer program product of claim 15, wherein the interface is native to the plurality of storage systems, and the interface comprises one of a Graphical User Interface (GUI) or a Command-Line Interface (CLI).
